(19) United States
(12) Patent Application Publication
(10) Pub. No.: US 2013/0262544 A1
(43) Pub. Date: Oct. 3, 2013

(54) ELECTRONIC MULTIPLIER AND DIGITAL SIGNAL PROCESSOR INCLUDING THE SAME

(71) Applicant: SAMSUNG ELECTRONICS CO., LTD., Suwon-si (KR)

(72) Inventors: Yong-Ki Lee, Hwaseong-si (KR); Jong-Hoon Shin, Hwaseong-si (KR); Kyoung-Moon Ahn, Seoul (KR); Ji-Su Kang, Seoul (KR); Sun-Soo Shin, Seoul (KR)

(73) Assignee: SAMSUNG ELECTRONICS CO., LTD., Suwon-si (KR)

(21) Appl. No.: 13/716,994

(22) Filed: Dec. 17, 2012

(30) Foreign Application Priority Data
Apr. 2, 2012 (KR) 10-2012-0033804

(51) Int. Cl. G06F 7/533; G06F 7/58

(52) U.S. Cl. CPC G06F 7/533; G06F 7/588
USPC 708/250; 708/628

(57) ABSTRACT

An electronic multiplier, such as a multiplication circuit, may include a partial product generator, a Booth code encoder and an accumulator. The partial product generator may generate partial product data based on a Booth code and multiplicand data. The Booth code encoder may generate the Booth code based on multiplier data. The Booth code may include a zero-generation Booth code and a zero-avoidance Booth code. The Booth code encoder may selectively generate the zero-generation Booth code or the zero-avoidance Booth code when the partial product data correspond to a partial product of zero. The accumulator accumulates the partial product data to provide a multiplication result of the multiplicand data and the multiplier data.

### CROSS-REFERENCE TO RELATED APPLICATION

This application claims priority under 35 USC §119 to Korean Patent Application No. 2012-0033804, filed on Apr. 2, 2012, in the Korean Intellectual Property Office (KIPO), the contents of which are herein incorporated by reference in their entirety.

### BACKGROUND

1. Technical Field

Example embodiments in accordance with principles of inventive concepts relate generally to security schemes, and more particularly to multiplication circuits electronic multipliers, digital signal processors and associated methods to provide a countermeasure against a side channel analysis (SCA) employing a power analysis.

2. Description of the Related Art

One of the most important elements of a security processor (also referred to herein as a “secure processor”) is one or more countermeasures against side channel analysis (SCA).

Attacks by side channel may generally be referred to as a side channel analysis (SCA). Side channel analysis may include a timing attack based on timing information, a fault-insertion attack based on fault and malfunction information, an electromagnetic analysis attack based on electromagnetic information, or a power analysis attack based on power information, for example.

Among these forms of attack, the power analysis attack refers to a crypto analysis technology, which reads binary codes of a variety of information by observing variation in voltage or power of an IC chip upon the operation of a crypto process, which may be embedded in a card. A crypto secret key may analyze important information through a statistical scheme, and enable counterfeit/forgery of the information. The power analysis attack is classified into a simple power analysis, a differential power analysis, an inferential power analysis, and a high-order differential power analysis. Because the differential power analysis may infer the secret key by using several apparatuses capable of observing voltage variation, the differential power analysis is more effective than a brute-force attack using a dedicated crypto analysis device or a super computer.

A multiplication operation may provide particular vulnerability to differential power analysis. For example, if a multiplier includes “0 (zero),” power consumption associated with the multiplication operation may vary widely because a partial product becomes “0:” a condition that may be readily detectable in an SCA scheme such as a differential power analysis.

The number of transistors subject to perform switching operation may vary depending on an input value, and, thus, the level of power consumption may vary depending on the number of the switched transistors. Such a difference in power consumption may serve as a point of vulnerability against differential power analysis. To provide a countermeasure against a power analysis attack, the dependency of power consumption upon input values may be removed.

However, countermeasures against a power analysis attack may be remarkably burdensome and, as a result, the size of a secure processor may be significantly increased, average power consumption may be remarkably increased, or the number of cycles necessary for performing an operation may be increased.

### SUMMARY

Exemplary embodiments in accordance with principles of inventive concepts provide a multiplication circuit or an electronic multiplier capable of effectively preventing significant variation of power consumption caused by zero ‘0’ input in the multiplication.

Exemplary embodiments in accordance with principles of inventive concepts provide a digital signal processor capable of improving countermeasures against an SCA.

According to exemplary embodiments in accordance with principles of inventive concepts, an electronic multiplier, such as a multiplication circuit, includes a partial product generator, a Booth code encoder and an accumulator. The partial product generator may generate partial product data based on a Booth code and multiplicand data. The Booth code encoder may generate the Booth code based on multiplier data. The Booth code may include a zero-generation Booth code and a zero-avoidance Booth code different from each other, and the Booth code encoder may selectively generate the zero-generation Booth code or the zero-avoidance Booth code when the partial product data correspond to a partial product of zero. The accumulator accumulates the partial product data to provide a multiplication result of the multiplicand data and the multiplier data.

A multiplication circuit in accordance with principles of inventive concepts may further include a random number generator to generate a selection signal based on a random number, and the Booth code encoder may randomly generate the zero-generation Booth code or a zero-avoidance Booth code in response to the selection signal.

In accordance with principles of inventive concepts, the partial product generator may generate first zero-expression partial product data in response to the zero-generation Booth code and generate second zero-expression partial product data in response to the zero-avoidance Booth code, such that all bits of the first zero-expression partial product data have “0”, and one or more bits of the first zero-expression partial product data have “1”.

In accordance with principles of inventive concepts, the first zero-expression partial product data and the second zero-expression partial product data may have constant values regardless of the multiplicand data.

In accordance with principles of inventive concepts, the first zero-expression partial product data may include a first zero-expression code and a first sign code, such that all bits of the first zero-expression code have “0”, the first sign code corresponds to two's compliment of the first zero-expression code.

In accordance with principles of inventive concepts, the accumulator may calculate the product of zero by summing the first zero-expression code and the first sign code.

In accordance with principles of inventive concepts, the second zero-expression partial product data may include a second zero-expression code and a second sign code, such that one or more bits of the second zero-expression code have “1”, and the second sign code corresponds to two's compliment of the second zero-expression code.

In accordance with principles of inventive concepts, all bits of the second zero-expression code may have “1” and the second sign bit may be an one-bit code having “1”.

In accordance with principles of inventive concepts, the accumulator may calculate the product of zero by summing the second zero-expression code and the second sign code.

In accordance with principles of inventive concepts, the Booth code encoder may control generation rates of the zero-generation Booth code and the zero-avoidance Booth code based on average power of the electronic multiplier.

In accordance with principles of inventive concepts, all bits of the zero-generation Booth code may have “0” and all bits of the zero-avoidance Booth code may have “1”.

In accordance with principles of inventive concepts, when the multiplicand data are n-bit data where n is a positive integer, the first zero-expression partial product data may include a first zero-expression code of n+1 bits and a first sign code of one bit, such that the n+1 bits of the first zero-expression code have “0”, and the one bit of the first sign code has “0”, and the second zero-expression partial product data may include a second zero-expression code of n+1 bits and a second sign code of one bit, such that the n+1 bits of the second zero-expression code have “1”, and the one bit of the second sign code has “1”.

In accordance with principles of inventive concepts, a digital signal processor includes a random number generator, a partial product generator, a Booth code encoder, an accumulator and a controller. The random number generator generates a selection signal based on a random number. The partial product generator generates partial product data based on a Booth code and multiplicand data. The Booth code encoder generates the Booth code based on multiplier data. The Booth code include a zero-generation Booth code and a zero-avoidance Booth code different from each other, and the Booth code encoder selectively generates the zero-generation Booth code or the zero-avoidance Booth code in response to the selection signal when the partial product data correspond to a partial product of zero. The accumulator accumulates the partial product data to provide a multiplication result of the multiplicand data and the multiplier data. The controller controls operations of the random number generator, the partial product generator, the Booth code encoder, and the accumulator.

In accordance with principles of inventive concepts, the partial product generator may generate first zero-expression partial product data in response to the zero-generation Booth code and generate second zero-expression partial product data in response to the zero-avoidance Booth code, such that all bits of the first zero-expression partial product data have “0”, and one or more bits of the second zero-expression partial product data have “1”

In accordance with principles of inventive concepts, the first zero-expression partial product data may include a first zero-expression code and a first sign code, such that all bits of the first zero-expression code have “0” and the first sign code corresponds to two's compliment of the first zero-expression code, and the second zero-expression partial product data may include a second zero-expression code and a second sign code, such that one or more bits of the second zero-expression code have “1” and the second sign code corresponds to two's compliment of the second zero-expression code.

In accordance with principles of inventive concepts, in circuits, devices and/or systems carrying out the digit-serial multiplication using the Booth process, values of partial product data can be prevented from being continuously set to ‘0’ without providing an additional hardware, so remarkable variation of power consumption may not occur. Thus, the multiplication is possible with effective countermeasures against the SCA to the secure process. In addition, additional hardware may not be necessary, the overhead for the average power consumption can be reduced, the additional cycle may not be added, and the operating frequency may not be lowered. Thus, the fundamental structure of the existing H/W can be utilized when the multiplication is carried out in a Booth recoding scheme employing the Booth process, which is adopted in most crypto processors.

In accordance with principles of inventive concepts, a method in an electronic multiplier, includes the electronic multiplier generating partial product data based on a Booth code and multiplicand data; generating the Booth code based on multiplier data, the Booth code including a zero-generation Booth code and a zero-avoidance Booth code, the electronic multiplier selectively generating the zero-generation Booth code or the zero-avoidance Booth code when the partial product data correspond to a partial product of zero; and accumulating the partial product data to provide a multiplication result of the multiplicand data and the multiplier data.

In accordance with principles of inventive concepts, a method further includes: generating a selection signal based on a random number, wherein the zero-generation Booth code or a zero-avoidance Booth code is randomly generated in response to the selection signal.

In accordance with principles of inventive concepts, a method further includes: generating a first zero-expression partial product data in response to the zero-generation Booth code and generating second zero-expression partial product data in response to the zero-avoidance Booth code, all bits of the first zero-expression partial product data having “0”, one or more bits of the second zero-expression partial product data having “1”.

In accordance with principles of inventive concepts, a method in which a digital signal processor includes an electronic multiplier further includes: a random number generator generating a selection signal based on a random number; a partial product generator generating partial product data based on a Booth code and multiplicand data; a Booth code encoder generating the Booth code based on multiplier data, the Booth code including a zero-generation Booth code and a zero-avoidance Booth code, the Booth code encoder selectively generating the zero-generation Booth code or the zero-avoidance Booth code in response to the selection signal when the partial product data correspond to a partial product of zero; an accumulator accumulates the partial product data to provide a multiplication result of the multiplicand data and the multiplier data; and a controller controlling operations of the random number generator, the partial product generator, the Booth code encoder, and the accumulator.

In accordance with principles of inventive concepts, a method further includes: the partial product generator generating first zero-expression partial product data in response to the zero-generation Booth code and generates second zero-expression partial product data in response to the zero-avoidance Booth code, all bits of the first zero-expression partial product data having “0”, one or more bits of the second zero-expression partial product data having “1”

### BRIEF DESCRIPTION OF THE DRAWINGS

Illustrative, non-limiting exemplary embodiments in accordance with principles of inventive concepts will be more clearly understood from the following detailed description taken in conjunction with the accompanying drawings.

FIG. 1 is a block diagram illustrating a digital signal processor in accordance with principles of inventive concepts;

FIG. 2 is a block diagram illustrating a multiplication circuit in accordance with principles of inventive concepts;

FIG. 3 is a block diagram illustrating an exemplary embodiment of a partial product generator in accordance with principles of inventive concepts in the multiplication circuit of FIG. 2;

FIG. 4 is a circuit diagram illustrating an example of a partial product block in accordance with principles of inventive concepts in the partial product generator of FIG. 3.

FIG. 5 is a diagram for explaining a digit-serial multiplication in accordance with principles of inventive concepts.

FIG. 6 is a flowchart illustrating a multiplication method in a computer system in accordance with principles of inventive concepts.

### DETAILED DESCRIPTION OF THE EMBODIMENTS

Exemplary embodiments in accordance with principles of inventive concepts will now be described more fully with reference to the accompanying drawings, in which exemplary embodiments are shown. Exemplary embodiments in accordance with principles of inventive concepts may, however, be embodied in many different forms and should not be construed as being limited to the embodiments set forth herein; rather, these embodiments are provided so that this disclosure will be thorough and complete, and will fully convey the concept of exemplary embodiments to those of ordinary skill in the art. In the drawings, the thicknesses of layers and regions may be exaggerated for clarity. Like reference numerals in the drawings denote like elements, and thus their description may not be repeated.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers indicate like elements throughout. As used herein the term “and/or” includes any and all combinations of one or more of the associated listed items. Other words used to describe the relationship between elements or layers should be interpreted in a like fashion (for example, “between” versus “directly between,” “adjacent” versus “directly adjacent,” “on” versus “directly on”). The word “or” is used in an inclusive sense, unless otherwise indicated.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of exemplary embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “bottom,” “below,” “lower,” or “beneath” other elements or features would then be oriented “atop,” or “above,” the other elements or features. Thus, the exemplary terms “bottom,” or “below” can encompass both an orientation of above and below, top and bottom. The device may be otherwise oriented (rotated 90 degrees or at other orientations) and the spatially relative descriptors used herein interpreted accordingly.

The terminology used herein is for the purpose of describing particular embodiments only and is not intended to be limiting of exemplary embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which exemplary embodiments in accordance with principles of inventive concepts belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein. Although the terms first, second, third etc. may be used herein to describe various elements, these elements should not be limited by these terms. These terms are used to distinguish one element from another. Thus, a first element discussed below could be termed a second element without departing from the teachings of the present inventive concept. As used herein, the term “and/or” includes any and all combinations of one or more of the associated listed items.

It should also be noted that in some alternative implementations, the functions/acts noted in blocks may occur out of the order noted in flowcharts. For example, two blocks shown in succession may in fact be executed substantially concurrently or the blocks may sometimes be executed in the reverse order, depending upon the functionality/acts involved.

Similar to general processors, one of basic operations in a secure processor is a multiplication. In particular, a processor executing a public-key process (also referred to as a public-key algorithm) performs arithmetic operations (addition/subtraction, multiplication, and modular operations) on relatively large numbers. In the case of a Revest Shamir Adleman (RSA) system, an operator must have a size of at least 1024 bits to guarantee secure operation. For this reason, most public-key processors adopt the operation scheme of digit-serial multiplier. Process 1 illustrates an exemplary serial multiplication.

### Process 1: Serial Multiplication

Inputs: Positive integers A and B, where B=Σᵢ₌₀ⁿ⁻¹bᵢ2ⁱ,
n is an operand size, and bᵢ=0 or 1

Output: Result of the multiplication: C<=A*B
1. C<=0
2. For i from n−1 down to 0 do
   (i). T<=C*2
(ii). T<=T+bᵢ*A
   (iii). C<=T
3. Return C

If bᵢ is 0, the variation in power consumption by a processor performing the serial multiplication may be estimated as follows.

(1) In process 1, 2-(i) may be implemented through a simple shift operation (that is, wiring), and 2-(ii) is the procedure causing the significant power consumption. If bᵢ is 0, bᵢ*A is 0, so a value of a parameter T is not changed in 2-(ii). Thus, the power consumption is lower than the average power consumption.

(2) If bᵢ remains 0 at least two times, the value of the parameter T is not changed in 2-(ii) and bᵢ*A remains fixed at 0. As a result, the switching activity of a logic gate for evaluating bᵢ*A is significantly reduced, and, concomitantly, so is the power consumption.

(3) If (2) occurs at a portion of MSD (Most Significant Digit) of an operator B, variation of the power consumption is even more marked. This is because the parameter T and bᵢ*A are not changed in 2-(ii) and a register value is fixed to 0 at 2-(iii) where the register is updated so the register value is not changed.

Given the above, the value of bᵢ may be revealed by monitoring power consumption in a SCA attack: a serious vulnerability for a secure processor. Conventional countermeasures against a SCA attack may be classified, generally, as either hiding or masking.

A hiding approach reduces the variation power consumption by reducing side channel signals or increasing noise. One disadvantage of a hiding scheme is that the circuit area and the average power consumption of a device employing may be more than doubled. In addition, because logic evaluation operations may be performed only when a clock is low, the overall performance may be degraded.

According to a masking scheme, the masking operation is performed before the crypto operation to randomize the input used for the crypto operation. In order to compensate for the masking operation, an unmasking operation is performed after the crypto operation, so that the equivalent operation result is obtained. A disadvantage of the masking scheme is the fact that there is no masking effect when A or B is 0.

Exemplary embodiments apparatus and methods in accordance with principles of inventive concepts effectively remove the vulnerability to SCA caused by bᵢ having a value of 0. Conventional countermeasures may be used against simple power analysis (SPA) and represent great overhead. However, in accordance with principles of inventive concepts, the overhead with respect to circuit area and the average power consumption may be reduced to the point of insignificance.

In exemplary embodiments in accordance with principles of inventive concepts, a circuit or processor may produce the partial product of zero in an advantageous novel manner, which can be expressed as:

0=−1+1=111 . . . 111₍ₛ₎+1₍₂₎

In the above equation, 0 is the sum of −1 and 1. If −1 is expressed as two's complement, −1 can be expressed as 111 . . . 111₍₂₎. Thus, 0 may be expressed as the sum of 111 . . . 111₍₂₎ and 2₍₂₎.

When a circuit, or processor, calculates the sum of 111 . . . 111₍₂₎ and 1₍₂₎, an overflow is generated and 0 is produced as the result of addition. That is, if 0 is added in the step 2 of the process 1, the power consumption may be reduced. However, if ‘111 . . . 111₍₂₎+1₍₂₎’ is added instead of simply adding 0, since 0 is added through the more complex calculation procedure, the reduction in power consumption can be prevented, thereby reducing the vulnerability to SCA in accordance with principles of inventive concepts. If the above procedure is simply applied to all of repeating 0s, ‘111 . . . 111₍₂₎+1₍₂₎’ is consecutively represented, so the toggling of the corresponding logic gate is not generated, thus, the sophisticated control may be necessary.

In general, in accordance with principles of inventive concepts, the digit-serial multiplier or the digit-serial multiplication circuit is used in order to improve the performance of the serial multiplication as shown in the process 1. In serial multiplication, one bit of the multiplier data is processed in one cycle. However, in the digit-serial multiplier, several bits of the multiplier data are processed in one cycle. Thus, If a digit size is d, the number of cycles required for multiplication is reduced to 1/d when using a digit-serial multiplier. The process of the digit-serial multiplier is shown in the process 2. In the process 2, the partial product is calculated in 2-(II). In the process 2, 2-(I) is processed through the simple shift operation, and hardware may be implemented as wiring, without allocating an additional logic gate. In order to reduce the number of the partial products, a recoding scheme may be adopted instead of multiplying bᵢ in the binary type. Booth recoding may be used as the recoding scheme, for example.

### Process 2: Digit-Serial Multiplication

Inputs: Positive integers A and B, where b=Σᵢ₌₀^{k-1}bᵢ2^{di}, n is an operand size,
d is a digit size, k=[n/d], and bi=[0, 1, 2, . . . , 2^{d}−1]

Output: Result of the multiplication: C<=A*B
1. C<=0
2. For i from k−1 down to 0 do
   I. T<=C*2^{d}
   II. T<=T+bi*A
   III. C<=T
2. Return C

In exemplary embodiments in accordance with principles of inventive concepts, extended Booth recoding expressed in table 1 may be used.

TABLE 1
Extended Booth code

| receding value | sel0 | sel1 | sel2 | sel3 |
|---|---|---|---|---|
| −2 | 1 | 0 | 1 | 0 |
| −1 | 1 | 0 | 0 | 1 |
| 0 | 0 | 0 | 0 | 0 |
| | 1 | 1 | 1 | 1 |
| 1 | 0 | 1 | 0 | 1 |
| 2 | 0 | 1 | 1 | 0 |

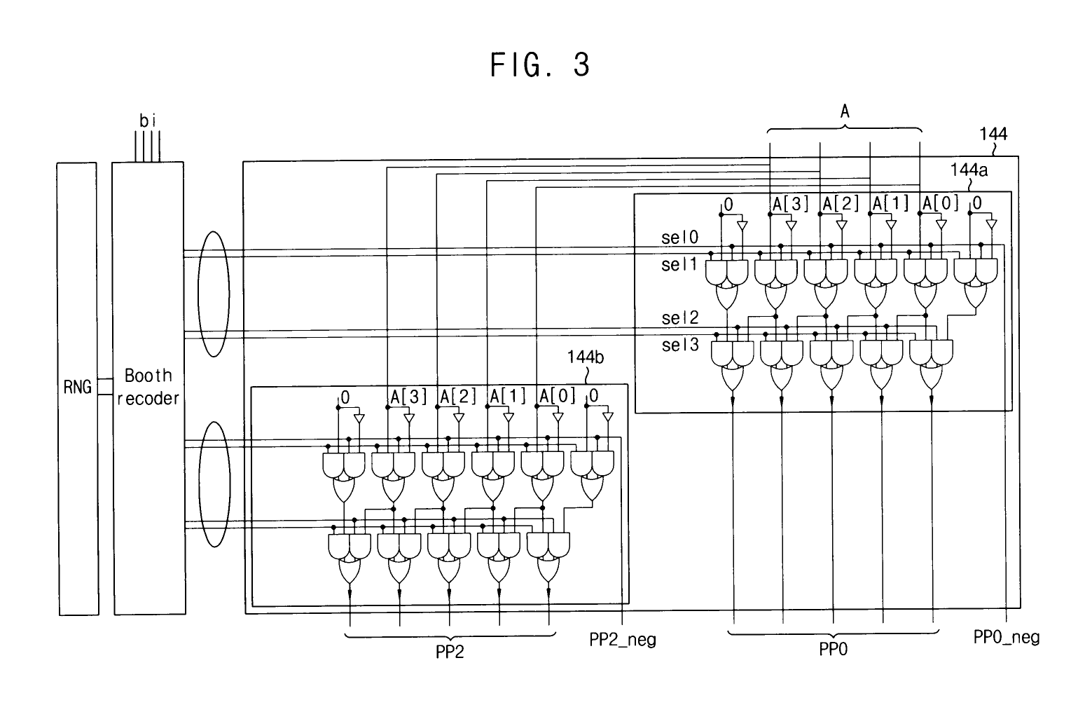

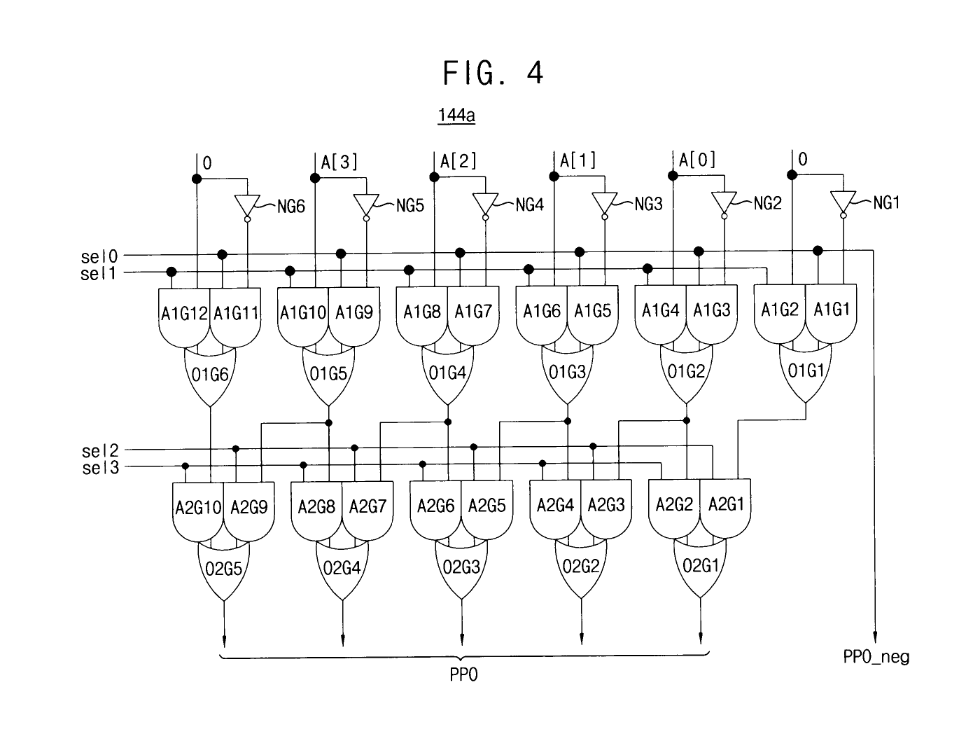

In exemplary embodiments in accordance with principles of inventive concepts, two selections (sel0=sel1=sel2=sel3=0 or sel0=sel1=sel2=sel3=1) may exist when the partial product is “0”. In other words, a zero-generation Booth code (sel0=sel1=sel2=sel3=0) or a zero-avoidance Booth code (sel0=sel1=sel2=sel3=1) may be selected to yield the partial product of zero. In exemplary embodiments in accordance with principles of inventive concepts, the extended Booth code may be variously designed according to the structure of the partial product generator illustrated in FIGS. 3 and 4. The scope of exemplary embodiments in accordance with principles of inventive concepts are not limited to the code expression scheme described above, but the zero-avoidance Booth code may be generated and used together with the zero-generation Booth code.

A selection procedure in accordance with principles of inventive concepts may be described as follows:

(1) always apply ‘sel0=sel1=sel2=sel3=0’.

(2) always apply ‘sel0=sel1=sel2=sel3=1’.

(3) alternately apply ‘sel0=sel1=sel2=sel3=0’ and ‘sel0=sel1=sel2=sel3=1’.

(4) randomly (pseudo-randomly) apply ‘sel0=sel1=sel2=sel3=0’ and ‘sel0=sel1=sel2=sel3=1’.

In the case of (1), as described above, the power consumption is lower than the average power consumption because the partial product is generated as “0”, so the case (1) may be the target of the SCA.

If the modified scheme is always used as in the case of (2), there is improvement as compared with the case (1). However, if the recoding value is consecutively 0 in at least two times, the power consumption may be lower than the average power consumption. This is because the toggling of the corresponding logic gate is not generated since the evaluation procedure for the ‘111 . . . 111₍₂₎+1₍₂₎’ is fixed.

In the case of (3), if the recoding value is consecutively 0 in at least two times, the power consumption may be higher than the average power consumption. That is, ‘000 . . . 000₍₂₎+0₍₂₎’ is changed to ‘111 . . . 111₍₂₎+1₍₂₎’ or vice versa, so all bit information is toggled, so that the power consumption may be higher than the average power consumption. Additionally, the power pattern may be fixed in the case of (3). Although the power consumption may approximate the average power consumption, if the same specific pattern is always represented, it may be a target of SCA.

The generation of the specific pattern may be avoided by applying the case of (4). Additionally, the higher than average power consumption associated with case (3) may be avoided by appropriately adjusting the random distribution. In some exemplary embodiments in accordance with principles of inventive concepts, generation rates of the zero-generation Booth code and the zero-avoidance Booth code may be controlled based on average power of the partial product generator.

Hereinafter, exemplary embodiments of hardware structure of a digit-serial multiplier in accordance with principles of inventive concepts will be described.

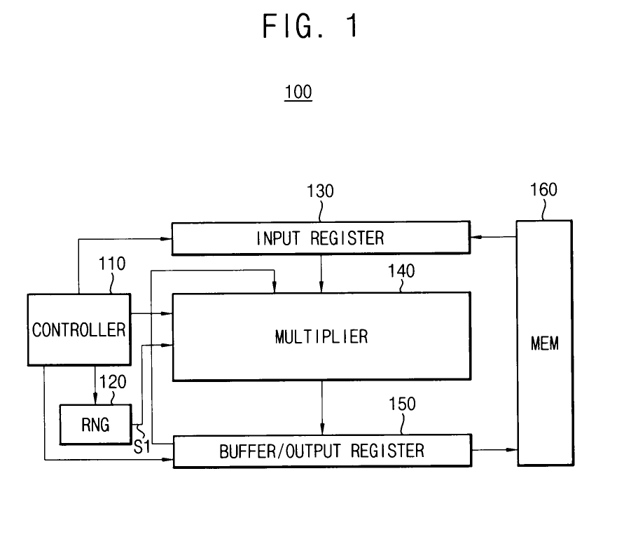

FIG. 1 is a block diagram illustrating an exemplary digital signal processor in accordance with principles of inventive concepts.

Referring to FIG. 1, a digital signal processor 100 includes a controller 110, a random number generator (RNG) 120, an input register 130, a multiplier 140, a buffer/output register 150 and a memory (MEM) 160.

The controller 110 performs data communication with external devices and controls operations of the components 120, 130, 140, 150 and 160 to execute a multiplication method in accordance with principles of inventive concepts.

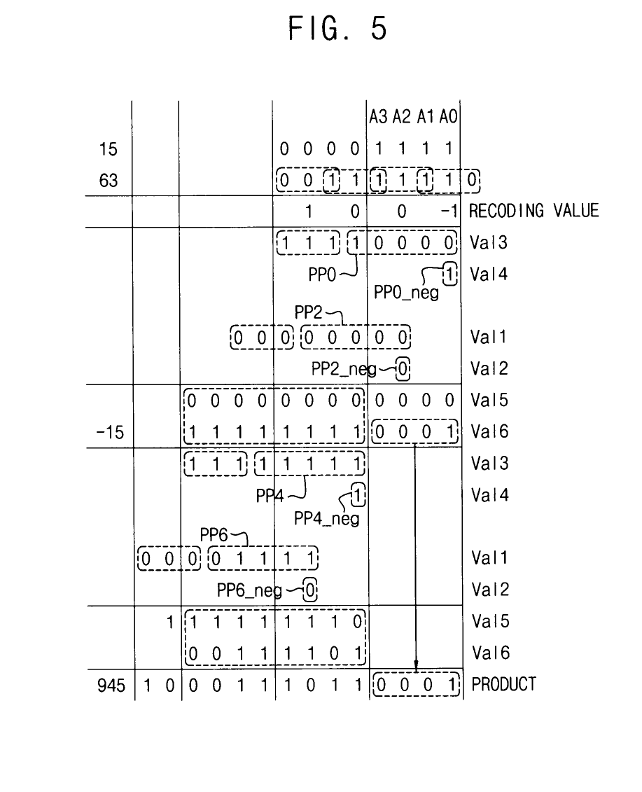

The random number generator 120 randomly generates 2-bit selection signal S1 by performing a random number generation process. Each random bit of the selection signal S1 has the status value as shown in table 2. In accordance with principles of inventive concepts, each random bit may be used as a signal for selecting one of the zero-generation Booth code and the zero-avoidance Booth code. For example, in an exemplary embodiment, “r0” is used as a signal for selecting one of the zero-generation Booth code and the zero-avoidance Booth code in one of two partial product blocks. In addition, “r1” is used as a signal for selecting one of the zero-generation Booth code and the zero-avoidance Booth code in the other of the two partial product blocks. In exemplary embodiments in accordance with principles of inventive concepts, two Booth codes are generated at a time, so 2-bit random number is used as will be further described with reference to FIGS. 3 and 5.

TABLE 2
Status value of selection signal S1

| r0 or r1 | Description |
|---|---|
| 0 | Selection of zero-generation Booth code |
| 1 | Selection of zero-avoidance Booth code |

In exemplary embodiments in accordance with principles of inventive concepts, the input register 130 provides multiplicand data and multiplier data to the multiplier 140, which are supplied from the memory 160, in response to the control signal from the controller 110.

In exemplary embodiments in accordance with principles of inventive concepts, the multiplier 140 is a digit-serial multiplier that receives the n-bit multiplicand data and the d-bit multiplier data from the input register 130 and receives the selection signal S1 from the random number generator 120 to perform the multiplication in the unit of digit and sends the result to the buffer/output register 150.

The buffer/output register 150 buffers the multiplication result under the control of the controller 110 and feeds back the multiplication result to the multiplier 140 for the next digit-serial multiplication. If the multiplication is completed for all digits, the buffer/output register 150 stores the final multiplication result in the memory 160.

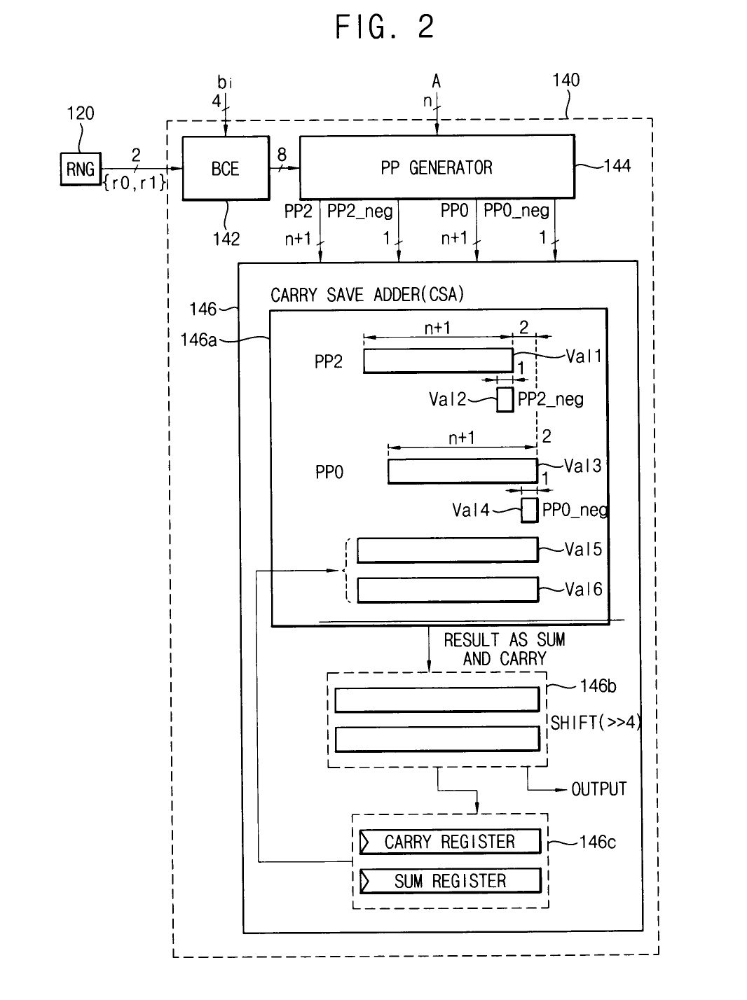

FIG. 2 is a block diagram illustrating an exemplary multiplication circuit in accordance with principles of inventive concepts. The multiplier circuit 140 includes a Booth code encoder (BCE) (or, a Booth encoder) 142, a partial product (PP) generator 144, and an accumulator 146.

The Booth encoder 142 generates a modified Booth code as shown in Table 3 by imputing the 4-bit multiplier (bi) and 2-bit selection signal S1.

TABLE 3

| | | | receded | | S1 | | | | | |
|---|---|---|---|---|---|---|---|---|---|---|
| bᵢ₊₁ | bᵢ | bᵢ₋₁ | digit | operation | r0 or r1 | sel0 | sel1 | sel2 | sel3 | Description |
| 1 | 0 | 0 | −2 | −2A | 0 or 1 | 1 | 0 | 1 | 0 | 1-bit shift of 2's complement of A |
| 1 | 0 | 1 | −1 | −1A | 0 or 1 | 1 | 0 | 0 | 1 | 2′ complement of A |
| 1 | 1 | 0 | | | | | | | | |
| 0 | 0 | 0 | 0 | 0A | 0 | 0 | 0 | 0 | 0 | Zero-generation Booth code |
| 1 | 1 | 1 | | | 1 | 1 | 1 | 1 | 1 | Zero-avoidance Booth code |
| 0 | 0 | 1 | 1 | 1A | 0 or 1 | 0 | 1 | 0 | 1 | A |
| 0 | 1 | 0 | | | | | | | | |
| 0 | 1 | 1 | 2 | 2A | 0 or 1 | 0 | 1 | 1 | 0 | 1-bit shift of A |

In order to implement an exemplary digit-serial multiplier in accordance with principles of inventive concepts, the multiplier data B is input into the Booth encoder 142 by dividing the multiplier data B in the unit of 4 bits. In example embodiments, 4-bit Booth code sel4 to sel1 corresponding to 2-LSBs (least significant bits) and 4-bit Booth code sel0 to sel3 corresponding to 2-MSBs (most significant bits) are generated in the Booth encoder 142, respectively. The number of Booth codes simultaneously output from the Booth encoder 142 may vary depending on the digit size.

In exemplary embodiments in accordance with principles of inventive concepts, if the zero value is generated as the partial product, the zero-generation Booth code (0000) and the zero-avoidance Booth code (1111) are randomly generated in response to the selection signal S1.

The partial product generator 144 receives the 8-bit code value from the Booth encoder 142 to output two n+1 bit partial product codes PP0 and PP2 for the n-bit multiplicand data A and 1-bit sign code PP0_neg and PP1_neg.

FIG. 3 is a block diagram illustrating a partial product generator in the multiplication circuit of FIG. 2 and FIG. 4 is a circuit diagram illustrating an example of a partial product block in the partial product generator of FIG. 3.

Referring to FIGS. 3 and 4, the partial product generator 144 includes two partial product blocks 144a and 144b. The partial product block 144a receives the 4-bit Booth code corresponding to 2-LSBs to generate the 5-bit partial product code PP0 and 1-bit sign code PP0_neg. The partial product block 144b receives the 4-bit Booth code corresponding to 2-MSBs to generate the 5-bit partial product code PP2 and 1-bit sign code PP2_neg. The two partial product blocks 144a and 144b may have the same structure.

In accordance with principles of inventive concepts, when the multiplicand data A are 4-bit data, each of the partial product blocks 144a and 144b may include six (=n+2) NOT gates NG1 to NG6, twelve (=2*(=n+2)) 1-level AND gates A1G1 to A1G12, six (=n+2) 1-level OR gates O1G1 to O1G6, ten (=2*(n+1)) 2-level AND gates A2G1 to A2G10, and five (=n+1) 2-level OR gates O2G1˜O2G5.

The least significant bit A0 of the multiplicand data A is input into one terminal of the AND gate A1G3 through the NOT gate NG2, at the same time, into one terminal of the AND gate A1G4. The Booth code bit sel0 is input into the other terminal of the AND gate A1G3 and the Booth code bit sel1 is input into the other terminal of the AND A1G4. Output terminals of the AND gate A1G3 and the AND gate A1G4 are connected to two input terminals of the OR O1G2, respectively. In this manner, the multiplicand data bit A1 is combined with the NOT gate NG3, AND gate A1G5, AND gate A1 G6 and OR gate O1G3, the multiplicand data bit A2 is combined with the NOT gate NG4, AND gate A1G7, AND gate A1G8 and OR gate O1G4, and the multiplicand data bit A3 is combined with the NOT gate NG5, AND gate A1G9, AND gate A1G10 and OR gate O1G5.

In exemplary embodiments in accordance with principles of inventive concepts, the zero value is arranged to the right of the least significant bit A0 of the multiplicand data A. The zero value is input into one terminal of the AND gate A1G1 through the NOT gate NG1, at the same time, into one terminal of the AND gate A1G2. The Booth code bit sel0 is input into the other terminal of the AND gate A1G1 and the Booth code bit sel1 is input into the other terminal of the AND gate A1G2. Output terminals of the AND gate A1G1 and the AND gate A1G2 are connected to two input terminals of the OR gate O1G1, respectively.

The zero value is also arranged to the left of the most significant bit A3 of the multiplicand data A. The zero value is input into one terminal of the AND gate A1G11 through the NOT gate NG6, at the same time, input into one terminal of the AND gate A1G12. The Booth code bit sel0 is input into the other terminal of the AND gate A1G11 and the Booth code bit sel1 is input into the other terminal of the AND gate A1G12. Output terminals of the AND gate A1G11 and the AND gate A1G12 are connected to two input terminals of the OR gate O1G6, respectively.

In exemplary embodiments in accordance with principles of inventive concepts, the output terminal of the OR gate O1G1 and the output terminal of the OR gate O1G2 are connected to one terminal of the 2-level AND gate A2G1 and one terminal of the AND gate A2G2, respectively. The Booth code bit sel2 is input into the other terminal of the AND gate A2G1 and the Booth code bit sel3 is input into the other terminal of the AND gate A2G2. The output terminals of the AND gate A2G1 and the AND gate A2G2 are connected to the input terminal of the OR gate O2G1, respectively. The output terminal of the OR gate O1G2 and the output terminal of the OR gate O1G3 are connected to one terminal of the 2-level AND gate A2G3 and one terminal of the AND gate A2G4, respectively. The Booth code bit sel2 is input into the other terminal of the AND gate A2G3 and the Booth code bit sel3 is input into the other terminal of the AND gate A2G4. The output terminals of the AND gate A2G3 and the AND gate A2G4 are connected to the input terminal of the OR gate O2G2, respectively. The output terminal of the OR gate O1G3 and the output terminal of the OR gate O1G4 are connected to one terminal of the 2-level AND gate A2G5 and one terminal of the AND gate A2G6, respectively. The Booth code bit sel2 is input into the other terminal of the AND gate A2G5 and the Booth code bit sel3 is input into the other terminal of the AND gate A2G6. The output terminals of the AND gate A2G5 and the AND gate A2G6 are connected to the input terminal of the OR gate O2G3, respectively. The output terminal of the OR gate O1G4 and the output terminal of the OR gate O1G5 are connected to one terminal of the 2-level AND gate A2G7 and one terminal of the AND gate A2G8, respectively. The Booth code bit sel2 is input into the other terminal of the AND gate A2G7 and the Booth code bit sel3 is input into the other terminal of the AND gate A2G8. The output terminals of the AND gate A2G7 and the AND gate A2G8 are connected to the input terminal of the OR gate O2G4, respectively. The output terminal of the OR gate O1G5 and the output terminal of the OR gate O1G6 are connected to one terminal of the 2-level AND gate A2G9 and one terminal of the AND gate A2G10, respectively. The Booth code bit sel2 is input into the other terminal of the AND gate A2G9 and the Booth code bit sel3 is input into the other terminal of the AND gate A2G10. The output terminals of the AND gate A2G9 and the AND gate A2G10 are connected to the input terminal of the OR gate O2G5, respectively.

In accordance with principles of inventive concepts, the partial product block 114a generates the partial products as shown in Table 4.

TABLE 4

| Booth code | | | | 1-level OR gate output | | | | | | 2-level OR gate output | | | | | |
|---|---|---|---|---|---|---|---|---|---|---|---|---|---|---|---|
| sel0 | sel1 | sel2 | sel3 | O1G6 | O1G5 | O1G4 | O1G3 | O1G2 | O1G1 | O2G5 | O2G4 | O2G3 | O2G2 | O2G1 | Description |
| 1 | 0 | 1 | 0 | 1 | /A3 | /A2 | /A1 | /A0 | 1 | /A3 | /A2 | /A1 | /A0 | 1 | 1 bit shift of A′ |
| | | | | | | | | | | | | | | | complement |
| 1 | 0 | 0 | 1 | 1 | /A3 | /A2 | /A1 | /A0 | 1 | 1 | /A3 | /A2 | /A1 | /A0 | A′ complement |
| 0 | 0 | 0 | 0 | 0 | 0 | 0 | 0 | 0 | 0 | 0 | 0 | 0 | 0 | 0 | Zero- |
| | | | | | | | | | | | | | | | generation |
| | | | | | | | | | | | | | | | Booth code |
| 1 | 1 | 1 | 1 | 1 | 1 | 1 | 1 | 1 | 1 | 1 | 1 | 1 | 1 | 1 | Zero- |
| | | | | | | | | | | | | | | | avoidance |
| | | | | | | | | | | | | | | | Booth code |
| 0 | 1 | 0 | 1 | 0 | A3 | A2 | A1 | A0 | 0 | 0 | A3 | A2 | A1 | A0 | A |
| 0 | 1 | 1 | 0 | 0 | A3 | A2 | A1 | A0 | 0 | A3 | A2 | A1 | A0 | 0 | 1 bit shift of A |

The value of the Booth code bit sel0 is output as 1-bit sign code PP0_neg.

In exemplary embodiments in accordance with principles of inventive concepts, when the result of the partial product is “0”, the partial product code is generated as the first zero-expression “00000” by the zero-generation Booth code (0000) and the sign code is generated as “0”. In addition, the partial product code is generated as “11111” by the zero-avoidance Booth code (1111) and the sign code is generated as “1”. The “11111”+“1” is applied to an adder 146a as the second zero-expression, which is another expression of “0”.

If the zero-generation Booth code (0000) is consecutively applied, there is no activated operation of MOS transistors in all gates of the partial product blocks 144a and 144b. That is, there is no switching operation, so the power consumption may be negligible.

However, when the zero-avoidance Booth code (1111) is applied after the zero-generation Booth code (0000) has been applied, six of twelve gates A1G1 to A1G12 in the partial product blocks 144a and 144b are subject to the switching operation regardless of the status of the multiplicand A, and the gates O1G1 to O1G6, A2G1 to A2G10, and O2G1 to O2G5 are subject to the switching operation, so the power consumption may be near maximum levels.

Referring to FIG. 2, in exemplary embodiments in accordance with principles of inventive concepts, the accumulator 146 includes a carry save adder (CSA) 146a, a shift processor 146b and a buffer register 146c. The buffer register 146c may be included in the buffer/output register 150 in FIG. 1.

The carry save adder 146a includes logic for adding up the PP2 value Val1, PP2_neg value Val2, PP0 value Val3, PP0_neg value Val4, and feedback values Val5 and Val6.

The least significant bit of the PP2 value Val1 is aligned with the digit having the high-order by 2 bits from the least significant digit of the PP0 value Val3, the PP2_neg value Val2 is aligned with the least significant digit of the PP2 value Val2, and the PP0_neg value Val4 is aligned with the least significant digit of the PP0 value Val3. These input values are added up with the feedback values Val5 and Val6 through the carry save add operation.

Because the PP2_neg value Val2 is aligned with the least significant digit of the PP2 value Val1 and the PP0_neg value Val4 is aligned with the least significant digit of the PP0 value Val3, the partial product code “11111” generated by the zero-avoidance Booth code (1111) is added to the sign code “1” to serve as two's complement of “0”.

In this manner, the carry save adder 146a adds the partial product of the multiplicand data A and the 4 digits of the multiplier data B to the sum, which is calculated in the previous digit, and sends the result to the shift processor 146b. In order to match the digit number with the calculation result of the 4 significant bits, the shift processor 146b shifts the sum value to the right by 4 bits. At this time, the values, which are output in the unit of 4 bits due to the shift operation, corresponds to the least significant section of the final operation result of the multiplier. The shifted carry value and sum value are stored in the buffer register 146c. The carry value and the sum value stored in the buffer register 146c are supplied as feedback values Val5 and Val6, which are fed back to the carry save adder 146a in order to be accumulated with the calculation result of next 4 significant bits of the multiplier data B.

When the partial product operation has been completed with respect to all digits of the multiplier data B, the value of the buffer register 146c is output. In exemplary embodiments in accordance with principles of inventive concepts, the final resultant value of the multiplication is the concatenated value of the 4-bit values, which are output through the shift operation, and the value of the buffer register 146c, which is output after the operation has been completed.

FIG. 5 is a diagram for explaining a digit-serial multiplication in accordance with principles of inventive concepts.

FIG. 5 illustrates the multiplication procedure of the multiplicand data “0000 1111” and the multiplier data “0011 1111” for decimal numbers 15 and 63. In FIG. 5, the right side represents the binary expression and the left side represents the corresponding decimal numbers.

In this exemplary embodiment in accordance with principles of inventive concepts, the multiplier data “0011 1111” is divided into 4 least significant bits “1111” and 4 most significant bits “0011” in the unit of 4 bits and then multiplied by the multiplicand data “0000 1111”.

First, the partial product between the multiplicand data and the 4 least significant bits “1111” of the multiplier data corresponding to the recording values “−1” and “0” is generated as the PP0 value “1 0000” and the PP0_neg value “1” and the PP2 value “0 0000” and the PP2_neg value “0” through the partial product generator 144.

The partial products, that is, the PP0 value “1 0000” and the PP0_neg value “1” supplied to the carry save adder 146a, are sign-extended as “1111 0000” and “1” and applied to the Val3 and Val4 operation logics, and the PP2 value “0 0000” and the PP2_neg value “0” are sign-extended as “0000 0000” and “0” and applied to the Val1 and Val2 operation logics.

The carry save addition result for the above values is generated as the carry value “0000 0000” and the sum value “1111 0001” and applied to the Val5 and Val6 operation logics. The value applied to the Val5 and Val6 operation logics is 4-bit shifted by the shift processor 146b, thereby generating “1111 1111 0001”. The 4 least significant bits “0001” are output as the 4 least significant digits in the multiplication result. The value of the most significant bits “1111 1111” is stored in the buffer register 146c for the next 4-bit operation. At this time, the carry value “0000 0000” is also stored in the buffer register 146c. The carry value “0000 0000” and the sum value “1111 1111” stored in the buffer register 146c is fed back as the feedback values Val5 and Val6 of the carry save adder 146a.

Then, the partial product between the multiplicand data and the 4 most significant bits “0011” of the multiplier data corresponding to the recording values “0” and “1” is generated as the PP4 value “1 1111” and the PP4_neg value “1” and the PP6 value “0 1111” and the PP6_neg value “0” through the partial product generator 144.

The partial products, that is, the PP4 value “1 1111” and the PP4_neg value “1” supplied to the carry save adder 146a, are sign-extended as “1111 1111” and “1” and applied to the Val3 and Val4 operation logics, and the PP6 value “0 1111” and the PP6_neg value “0” are sign-extended as “0000 1111” and “0” and applied to the Val1 and Val2 operation logics.

The carry save addition result for the above values is generated as the carry value “1 1111 1110” and the sum value “0011 1101” and applied to the Val5 and Val6 operation logics. The carry value “1 1111 1110” and the sum value “0011 1101” can be added in a separate logic to generate “10 0011 1011”. In the value “10 0011 1011”, the two MSBs “10” are overflow and ignored. The final output of the product is the concatenation of “0011 1011” and “0001”, that is, “0011 1011 0001”.

In exemplary embodiments in accordance with principles of inventive concepts, although the partial product of zero is generated twice, one of the partial products of zero is generated as “1 1111”+“1”, which is another expression of the partial product of zero “0 0000”+“0”, by the zero-avoidance Booth code (1111) to avoid the generation of the consecutive partial product code “0 0000”, thereby preventing the remarkable reduction in the power consumption.

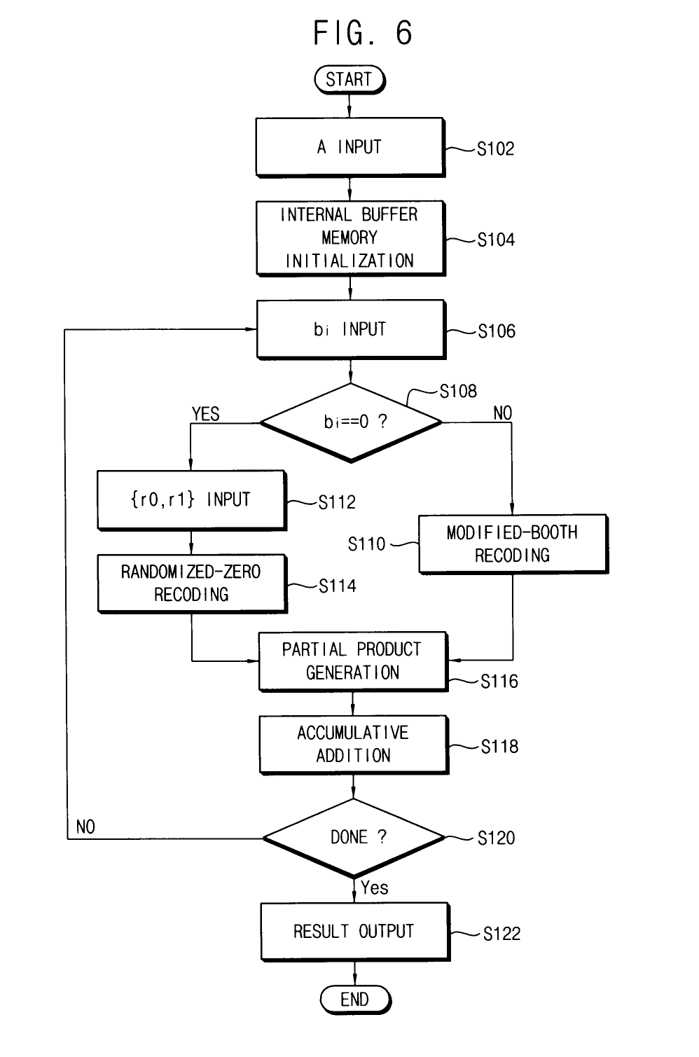

FIG. 6 is a flowchart illustrating a multiplication method in accordance with principles of inventive concepts, such as may be implemented in a processor.

First, the multiplicand data A is input into the input register (S 102). The internal buffer memory is initialized (S104). The multiplier data B is divided in the unit of digit, and it is determined whether the divided digit value (bi) is “0” (S 108). If the divided digit value (bi) is not “0”, the Booth code is generated through the modified Booth process and the Booth code is sent to the partial product generation module (modified-Booth recording) (S 110). In step S 108, if the divided digit value (bi) is “0”, random signal bits r0 and r1 are input (S112) to randomly generate one of the zero-generation Booth code and the zero-avoidance Booth code (randomized-zero recording) (S114). Then, the partial product code and the sign code are generated (S 116) in response to the Booth code generated in steps S110 and S114. The generated partial product code and the sign code are accumulated with the previous partial products (S 118). If the partial product generation and addition procedure has not been completed with respect to all divided digits, the process returns to step S106 to repeat steps S106 to S120. In step S120, if the accumulative addition has been completed with respect to all digits, the value of the accumulative addition is output as the product and the process is finished (S 122).

The operation or functions of each block or a set of the blocks illustrated in the block diagrams and flowchart can be implemented in various forms employing various combinations of hardware, firmware and software. A computer equipped with a SPP (special purpose processor), or other programmable devices based on software, firmware, or hard-wiring may be provided in order to realize the structure or means for implementing the operation or functions of each block or a set of the blocks illustrated in the block diagrams and flowchart.

In exemplary embodiments in accordance with principles of inventive concepts, although “111 . . . 111”+“1” is exclusively explained as another expression of “0” for the purpose of convenience, various expressions, such as “111 . . . 110”+“10” or “111 . . . 100”+“100”, can be adopted to express “0” within the scope of the inventive concept. That is, the second zero-expression partial product data in response to the zero-avoidance Booth code may include the second zero-expression code “111 . . . 110” and the first sign code “10”, or the second zero-expression code “111 . . . 100” and the first sign code “100,” for example.

Inventive concepts, as illustrated by exemplary embodiments, can be advantageously applied to various devices including circuits using digit-serial multiplier. In particular, inventive concepts may be advantageously applied to a secure processor that requires countermeasures against SCA.

The foregoing is illustrative of example embodiments and is not to be construed as limiting thereof. Although a few exemplary embodiments in accordance with principles of inventive concepts have been described, those skilled in the art will readily appreciate that many modifications are possible without materially departing from the novel teachings and advantages of the present inventive concepts. Accordingly, all such modifications are intended to be included within the scope of the present inventive concepts as defined in the claims. Therefore, it is to be understood that the foregoing is illustrative of various exemplary embodiments and is not to be construed as limited to the specific exemplary embodiments disclosed, and that modifications to the disclosed exemplary embodiments, as well as other exemplary embodiments, are intended to be included within the scope of the appended claims.

What is claimed is:

1. An electronic multiplier, comprising:
a partial product generator to generate partial product data based on a Booth code and multiplicand data;
a Booth code encoder to generate the Booth code based on multiplier data, the Booth code including a zero-generation Booth code and a zero-avoidance Booth code, the Booth code encoder selectively generating the zero-generation Booth code or the zero-avoidance Booth code when the partial product data correspond to a partial product of zero; and
an accumulator to accumulate the partial product data to provide a multiplication result of the multiplicand data and the multiplier data.

2. The electronic multiplier of claim 1, further comprising:
a random number generator to generate a selection signal based on a random number,
wherein the Booth code encoder is configured to randomly generate the zero-generation Booth code or a zero-avoidance Booth code in response to the selection signal.

3. The electronic multiplier of claim 1, wherein the partial product generator is configured to generate first zero-expression partial product data in response to the zero-generation Booth code and generate second zero-expression partial product data in response to the zero-avoidance Booth code, all bits of the first zero-expression partial product data having “0”, one or more bits of the first zero-expression partial product data having “1”.

4. The electronic multiplier of claim 3, wherein the first zero-expression partial product data and the second zero-expression partial product data have constant values regardless of the multiplicand data.

5. The electronic multiplier of claim 3, wherein the first zero-expression partial product data include a first zero-expression code and a first sign code, all bits of the first zero-expression code having “0”, the first sign code corresponding to two's compliment of the first zero-expression code.

6. The electronic multiplier of claim 5, wherein the accumulator is configured to calculate the product of zero by summing the first zero-expression code and the first sign code.

7. The electronic multiplier of claim 3, wherein the second zero-expression partial product data include a second zero-expression code and a second sign code, one or more bits of the second zero-expression code having “1”, the second sign code corresponding to two's compliment of the second zero-expression code.

8. The electronic multiplier of claim 7, wherein all bits of the second zero-expression code have “1” and the second sign bit is an one-bit code having “1”.

9. The electronic multiplier of claim 7, wherein the accumulator is configured to calculate the product of zero by summing the second zero-expression code and the second sign code.

10. The electronic multiplier of claim 1, wherein the Booth code encoder is configured to control generation rates of the zero-generation Booth code and the zero-avoidance Booth code based on average power of the electronic multiplier.

11. The electronic multiplier of claim 1, wherein all bits of the zero-generation Booth code have “0” and all bits of the zero-avoidance Booth code have “1”.

12. The electronic multiplier of claim 1, wherein when the multiplicand data are n-bit data where n is a positive integer, the first zero-expression partial product data include a first zero-expression code of n+1 bits and a first sign code of one bit, the n+1 bits of the first zero-expression code having “0”, the one bit of the first sign code having “0”, and the second zero-expression partial product data include a second zero-expression code of n+1 bits and a second sign code of one bit, the n+1 bits of the second zero-expression code having “1”, the one bit of the second sign code having “1”.

13. A digital signal processor comprising:
a random number generator to generate a selection signal based on a random number;
a partial product generator to generate partial product data based on a Booth code and multiplicand data;
a Booth code encoder to generate the Booth code based on multiplier data, the Booth code including a zero-generation Booth code and a zero-avoidance Booth code, the Booth code encoder selectively generating the zero-generation Booth code or the zero-avoidance Booth code in response to the selection signal when the partial product data correspond to a partial product of zero;
an accumulator to accumulate the partial product data to provide a multiplication result of the multiplicand data and the multiplier data; and
a controller to control operations of the random number generator, the partial product generator, the Booth code encoder, and the accumulator.

14. The digital signal processor of claim 13, wherein the partial product generator is configured to generate first zero-expression partial product data in response to the zero-generation Booth code and generate second zero-expression partial product data in response to the zero-avoidance Booth code, all bits of the first zero-expression partial product data having “0”, one or more bits of the second zero-expression partial product data having “1”

15. The digital signal processor of claim 14, wherein the first zero-expression partial product data include a first zero-expression code and a first sign code, all bits of the first zero-expression code having “0”, the first sign code corresponding to two's compliment of the first zero-expression code, and the second zero-expression partial product data include a second zero-expression code and a second sign code, one or more bits of the second zero-expression code having “1”, the second sign code corresponding to two's compliment of the second zero-expression code.

16. A method in an electronic multiplier, comprising:
the electronic multiplier generating partial product data based on a Booth code and multiplicand data;
generating the Booth code based on multiplier data, the Booth code including a zero-generation Booth code and a zero-avoidance Booth code, the electronic multiplier selectively generating the zero-generation Booth code or the zero-avoidance Booth code when the partial product data correspond to a partial product of zero; and
accumulating the partial product data to provide a multiplication result of the multiplicand data and the multiplier data.

17. The method of claim 16, further comprising:
generating a selection signal based on a random number,
wherein the zero-generation Booth code or a zero-avoidance Booth code is randomly generated in response to the selection signal.

18. The method of claim 17, further comprising:
generating a first zero-expression partial product data in response to the zero-generation Booth code and generating second zero-expression partial product data in response to the zero-avoidance Booth code, all bits of the first zero-expression partial product data having “0”, one or more bits of the second zero-expression partial product data having “1”.

19. The method of claim 18, wherein a digital signal processor includes the electronic multiplier; and
a random number generator generates a selection signal based on a random number;
a partial product generator generates partial product data based on a Booth code and multiplicand data;
a Booth code encoder generates the Booth code based on multiplier data, the Booth code including a zero-generation Booth code and a zero-avoidance Booth code, the Booth code encoder selectively generating the zero-generation Booth code or the zero-avoidance Booth code in response to the selection signal when the partial product data correspond to a partial product of zero;
an accumulator accumulates the partial product data to provide a multiplication result of the multiplicand data and the multiplier data; and
a controller controls operations of the random number generator, the partial product generator, the Booth code encoder, and the accumulator.

20. The method of claim 19, wherein the partial product generator generates first zero-expression partial product data in response to the zero-generation Booth code and generates second zero-expression partial product data in response to the zero-avoidance Booth code, all bits of the first zero-expression partial product data having “0”, one or more bits of the second zero-expression partial product data having “1”
